(19) United States
(12) Patent Application Publication
(10) Pub. No.: US 2023/0299568 A1
(43) Pub. Date: Sep. 21, 2023

(54) Rope Brake

(71) Applicant: David M. Bruns, Taylorville, IL (US)

(72) Inventor: David M. Bruns, Taylorville, IL (US)

(21) Appl. No.: 18/199,985

(22) Filed: May 22, 2023

Related U.S. Application Data
(63) Continuation-in-part of application No. 17/024,817, filed on Sep. 18, 2020.
(60) Provisional application No. 62/909,270, filed on Oct. 2, 2019.

(51) Int. Cl. H02G 1/04

(52) U.S. Cl. CPC H02G 1/04

(57) ABSTRACT

A rope brake apparatus is used to install a power line. Use of the rope brake enables a rope to be suspended above the ground during installation and thereby eliminates the need to block off the ground between power poles. The rope brake has a pair of opposed cam cleats mounted on a base adjacent each other for allowing movement of a rope between them in one direction and for preventing movement of a rope between them in an opposite direction.

### CROSS-REFERENCE TO RELATED APPLICATIONS

This application is a continuation-in-part of U.S. Nonprovisional patent application Ser. No. 17/024,817, Sep. 18, 2020, now pending, that claimed the benefit of U.S. Provisional Patent Application Ser. No. 62/909,270, Oct. 2, 2019.

### FIELD OF THE INVENTION

This invention relates to electric power transmission. More particularly, this invention relates to a rope brake for use during the installation of power lines.

### BACKGROUND OF THE INVENTION

Electric power is transmitted from power plants (or other place of generation) to electrical substations (or place of use) in metal power lines. The metal power lines are sometimes known as conductors. Referring to FIG. 1, the power is commonly transmitted in the form of high voltage three-phase alternating current in three separate power lines 10 with one neutral line 15. The four lines are generally uninsulated wires or cables and are generally located overhead on poles 20 where they are not likely to be contacted by persons. The three current-carrying lines are commonly attached to insulators 25 that are mounted on, or suspended from, a crossbar 30 attached to each pole. The crossbar is sometimes known as a cross arm or crossarm. The neutral line is commonly suspended in a clevis (a U-shaped bracket) 35 on each pole a short distance below the crossbar. The term “power line” is used herein to refer to individual current-carrying lines, neutral lines, and combinations thereof depending on the context.

Current-carrying power lines are installed on a span of poles using a multiple step procedure. The procedure is described as follows for a single power line. The procedure is repeated for each line. Referring to FIG. 2, the first step is to mount a temporary receiver (also known as an arm clamp) 40 for each line on each crossbar on each pole in the span. The receiver is located adjacent the insulator upon which the power line will ultimately be attached. Each receiver is secured to the crossbar with two bolts. A pulley (also known as a block or a stringing block) 45 is then connected to each crossbar receiver. The pulley has a top portion that pivots upwardly to allow the rope to be inserted and removed quickly without having to feed the rope through the pulley. A long section of non-conducting rope 50 from a rope reel 55 at the proximate end of the span is then pulled through the pulleys and draped over the crossbars for each line as shown in FIG. 3. The rope is sometimes known as a pilot line or a bull line. As the rope is pulled, it sags in between the poles.

The next step of the installation procedure is to pull the rope taut from the distal end of the span and connect the leading end of the rope to the leading end of a metal power line (also known as a conductor) 60 on a reel 65 at the distal end of the span as shown in FIG. 4. The rope and power line are generally connected using a Kellem grip 70 or the like as shown in FIG. 4A. The rope and power line are then pulled back through the pulleys in the opposite direction until the power line runs the entire span. The power line reel has a brake that provides resistance to create tension. The tension prevents the rope and attached power line from sagging as they are pulled in the opposite direction. The rope is then disconnected from the power line, the power line is removed from the pulleys, and the power line is attached to the insulators on the crossbars. The neutral line is generally installed in a similar manner except that the pulley is tied to the pole near the clevis receiver or temporarily attached in a similar manner. Various minor modifications of the above described procedure are common.

The power lines often cross roads or other areas that must be blocked off during the first stage of the installation because the ropes sag or drop completely to the ground. FIG. 3 illustrates such a step in the installation of a power line that crosses a road 75. Four ropes (one each for three current-carrying lines and a neutral line) are shown being installed on multiple poles. The rope reels that supply the ropes are to the left and the power line reels are to the right. In FIGS. 3 and 4, the insulators are omitted for clarity and the pulleys in the receivers are represented as ovals. Workers are at risk during any operation that stops traffic on a road. Furthermore, permits must be obtained before interrupting traffic on certain highways and railroads. It would be much more efficient and safer to install a power line in such a way that the ropes do not sag or drop down to the ground on the road as shown in FIG. 3.

Cam cleats that allow a rope to move in one direction while preventing the rope from moving in the opposite direction are well known in boating, but are unsuitable for installing power lines. An apparatus containing cams is disclosed in Vugrek, U.S. Pat. No. 4,019,715, Apr. 26, 1977. The Vugrek apparatus is used in conjunction with a cable lashing machine and a cable guide to connect a support strand to a telecommunications cable. The distance between the cams of the Vugrek apparatus is adjustable and the cams do not completely prevent movement of the apparatus along the support strand. The Vugrek apparatus is unsuitable for installing power lines.

Accordingly, there is a demand for an improved apparatus for installing power lines. There is also a demand for an improved assembly for installing power lines. There is also a demand for an improved method of installing power lines.

### SUMMARY OF THE INVENTION

A general object of this invention is to provide an improved apparatus for installing power lines. Another general object is to provide an improved assembly for installing power lines. Another general object is to provide an improved method for installing power lines.

I have invented an improved brake apparatus for installing power lines. The rope brake apparatus comprises: (a) a base having an upper surface and a lower surface; (b) a pair of adjacent cam cleats mounted on the upper surface of the base for allowing movement of the rope between them in one direction and for preventing movement of the rope between them in an opposite direction; (c) two side brackets projecting upwardly from the upper surface of the base for confining the rope; (d) a retainer removably attached to the side brackets for confining the rope; and (e) a member projecting downwardly from the lower surface of the base for attachment to the receiver.

I have also invented an improved assembly for installing power lines. The assembly comprises: (a) a power pole; (b) a receiver mounted on the power pole; and (c) a rope brake apparatus connected to the receiver, the rope brake apparatus comprising: (i) a base having an upper surface and a lower surface; (ii) a pair of adjacent cam cleats mounted on the upper surface of the base for allowing movement of the rope between them in one direction and for preventing movement of the rope between them in an opposite direction; (iii) two side brackets projecting upwardly from the upper surface of the base for confining the rope; (iv) a retainer removably attached to the side brackets for confining the rope; and (v) a member projecting downwardly from the lower surface of the base for attachment to the receiver.

I have further invented an improved method for installing power lines. The method comprises: (a) obtaining a power pole with a receiver and an adjacent insulator; (b) obtaining a rope with a leading end; (c) obtaining a power line with a leading end; (d) connecting to the receiver a rope brake apparatus comprising: (i) a base having an upper surface and a lower surface; (ii) a pair of adjacent cam cleats mounted on the upper surface of the base for allowing movement of the rope between them in one direction and for preventing movement of the rope between them in an opposite direction; (iii) two side brackets projecting upwardly from the upper surface of the base for confining the rope; (iv) a retainer removably attached to the side brackets for confining the rope; and (v) a member projecting downwardly from the lower surface of the base for connection to the receiver; (e) pulling the rope in a first direction through the cam cleats of the rope brake apparatus; (f) connecting the leading end of the rope to the leading end of the power line; (g) removing the rope from the rope brake apparatus; (h) disconnecting the rope brake apparatus from the receiver; (i) connecting a pulley to the receiver; (j) placing the rope into the pulley; (k) pulling the rope and the attached power line in a second direction through the pulley, which direction is opposite the first direction; (l) removing the power line from the pulley; and (m) attaching the power line to the adjacent insulator.

The apparatus, assembly, and method of this invention enable a rope to be suspended above the ground during installation and to thereby eliminate the need to block off the ground under the rope.

### BRIEF DESCRIPTION OF THE DRAWINGS

FIG. 1 is a perspective view of prior art power poles with three current-carrying lines and one neutral line on multiple poles.

FIG. 2 is a perspective view of a prior art installation step using a rope and a pulley mounted in a receiver.

FIG. 3 is a perspective view of a step in the prior art installation of four ropes for three current-carrying lines and one neutral line on multiple poles.

FIG. 4 is a perspective view of a subsequent step in the prior art installation of four ropes for three current-carrying lines and one neutral line on multiple poles.

FIG. 4A is a detail from FIG. 4 showing the connection of the rope to the power line.

FIG. 5 is an exploded perspective view of the rope brake apparatus of this invention.

FIG. 6 is an assembled view thereof.

FIG. 7 is a perspective view of the rope brake apparatus of this invention, a conventional pulley, and a conventional crossbar receiver.

FIG. 8 is an exploded perspective view of the clevis receiver of this invention.

FIG. 9 is an assembled view thereof.

FIG. 10 is an exploded perspective view of the rope brake apparatus of this invention with the clevis receiver.

FIG. 11 is an assembled view thereof.

FIG. 12 is a perspective view of the rope brake apparatus of this invention, a clevis receiver of this invention, a conventional pulley, and a conventional clevis.

FIG. 13 is a perspective view of four assemblies of this invention with four ropes for three power lines on a crossbar and a neutral line on a pole.

FIG. 14 is a perspective view of five assemblies of this invention with five ropes for three power lines and two neutral lines suspended from two crossbars.

FIG. 15 is a perspective view of the installation of four ropes for three current-carrying lines and one neutral line using the rope brake apparatus, assembly, and method of this invention.

FIG. 15A is a detail from FIG. 15 showing the connection of the rope to the power line.

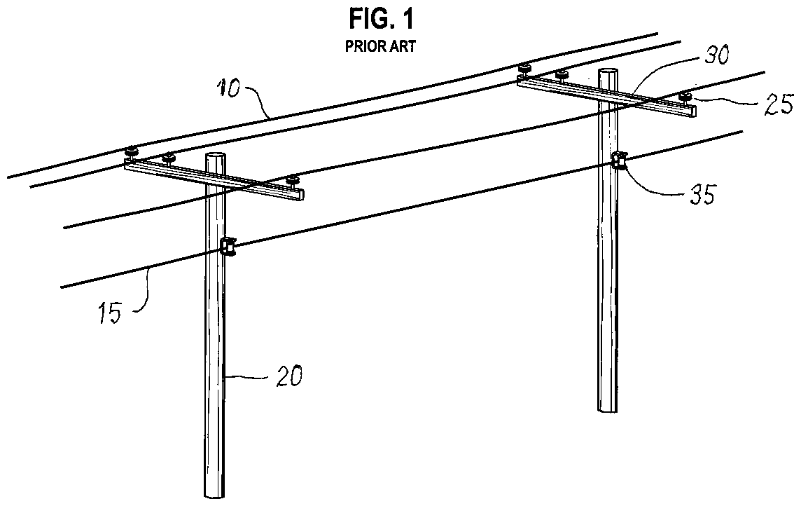

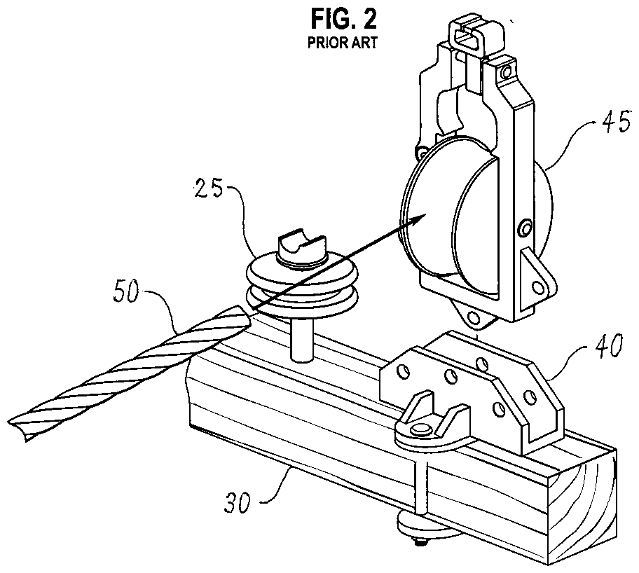

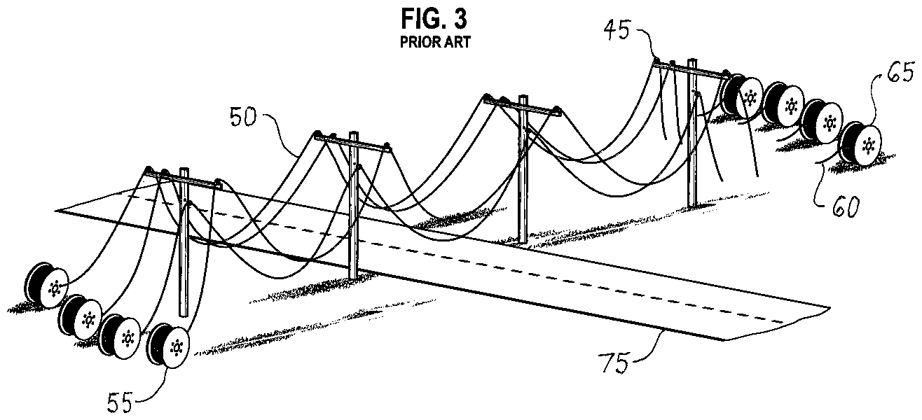

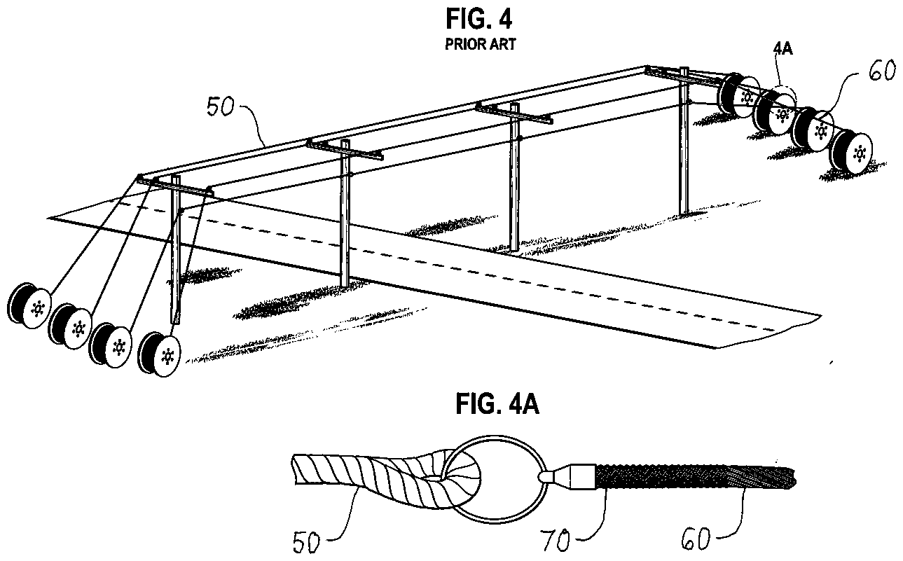

### DETAILED DESCRIPTION OF THE INVENTION

1. The Rope Brake Apparatus

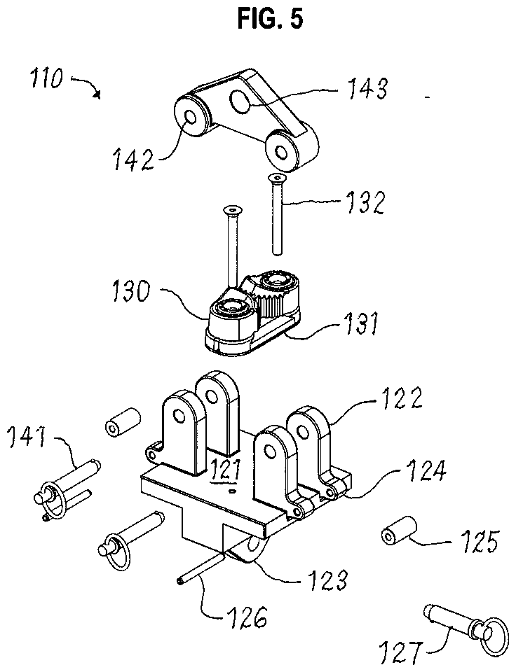

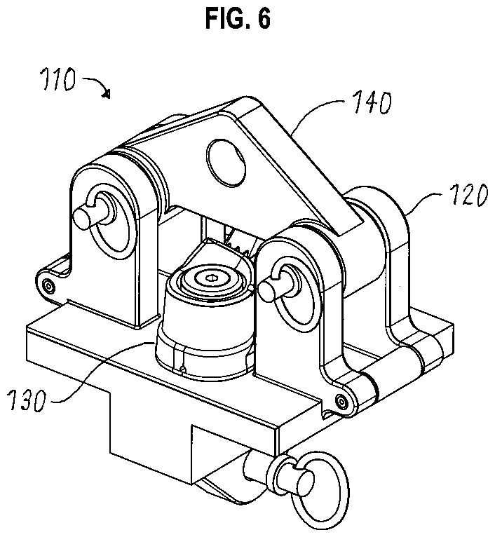

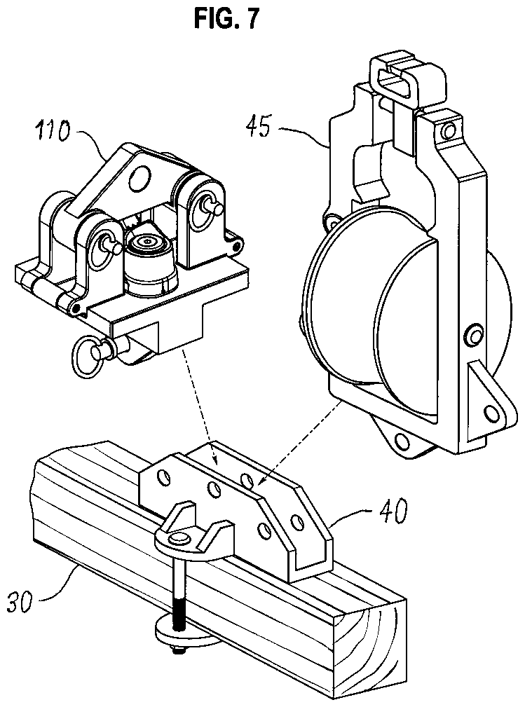

This invention is best understood by reference to the drawings. Referring first to FIGS. 5 and 6, a preferred embodiment of the rope brake apparatus 110 of this invention holds a rope (not shown) and allows movement of the rope in only one direction. The term “rope” is used herein to refer to all types of non-conducting ropes of natural or synthetic materials. Natural materials include hemp, linen, cotton, jute, sisal, and the like. Synthetic materials include nylon, polyesters, polyethylene, polypropylene, aramids, acrylics, and the like. The rope brake comprises three major components: a base 120, a pair of opposed cam cleats 130, and a retainer 140. The rope brake also comprises multiple screws and pins. As shown in FIG. 7, the rope brake fits into (connects to) the same conventional crossbar receiver 40 mounted on a crossbar 30 as a conventional pulley 45.

The base 120 of the rope brake has a flat upper surface 121 for accepting the opposed cam cleats. The upper surface of the base also has two pairs of upwardly extending brackets 122 for holding the retainer. The lower surface of the base has a downwardly extending projecting member 123 for connection to the spaced apart brackets of the receiver. As explained below, other means for connection to different types of receivers are also suitable. The front and rear of the base preferably have outwardly extending brackets 124 for holding nylon rollers 125 that are secured by roll pins 126. The nylon rollers facilitate movement of the rope through the apparatus. A pin 127 secures the rope brake apparatus to the receiver.

The opposed cam cleats 130 are adjacent each other and are spring loaded so they press against each other unless separated by a rope. The cam cleats have cleats (also known as ribs, grooves, teeth, etc.) to provide a secure connection to the rope. The ends of the cleats are preferably rounded to prevent cutting of the rope fibers. The opposed cam cleats are preferably mounted to a platform 131 and are preferably attached to the base with screws 132. The cam cleats are mounted in stationary positions (the distance between the cam cleats is not adjustable).

The retainer 140 is secured within the upwardly extending brackets of the base with pins 141. The retainer holds the rope in position between the opposed cam cleats. The retainer preferably has three holes. The two holes at the opposite ends 142 are used for attachment to the base. The central hole 143 is used to hang the apparatus from an overhead receiver as described below. FIG. 7 shows that the rope brake fits into a conventional receiver in the same way as a conventional pulley.

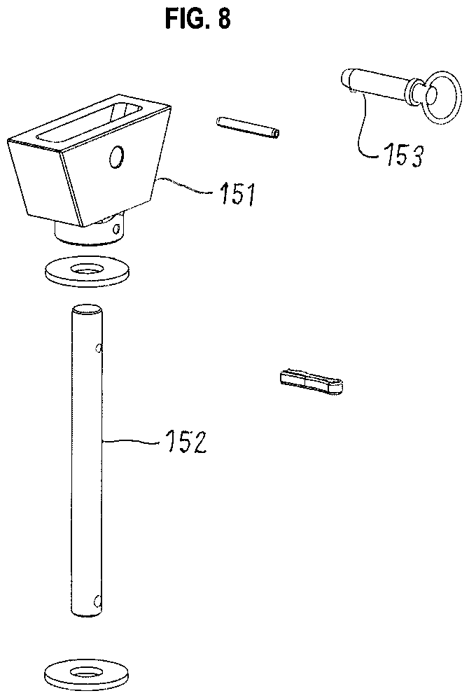

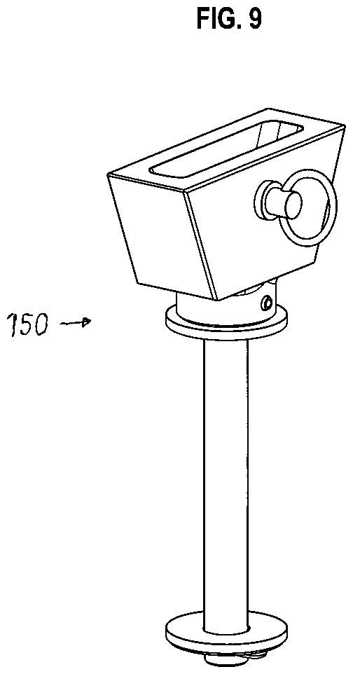

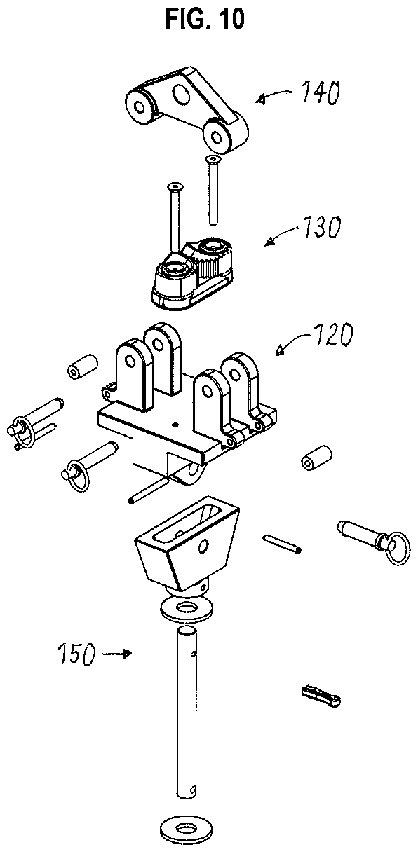

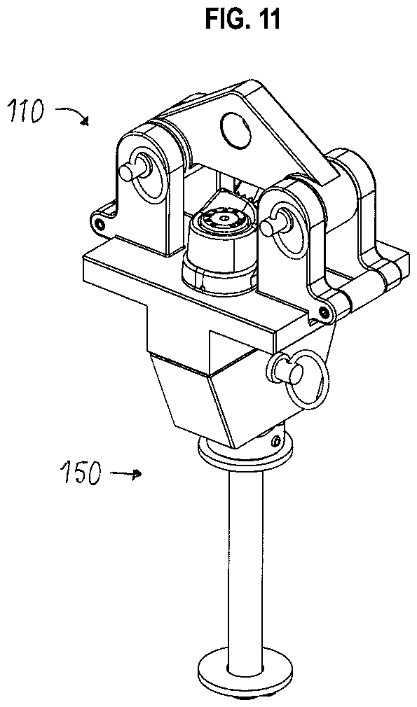

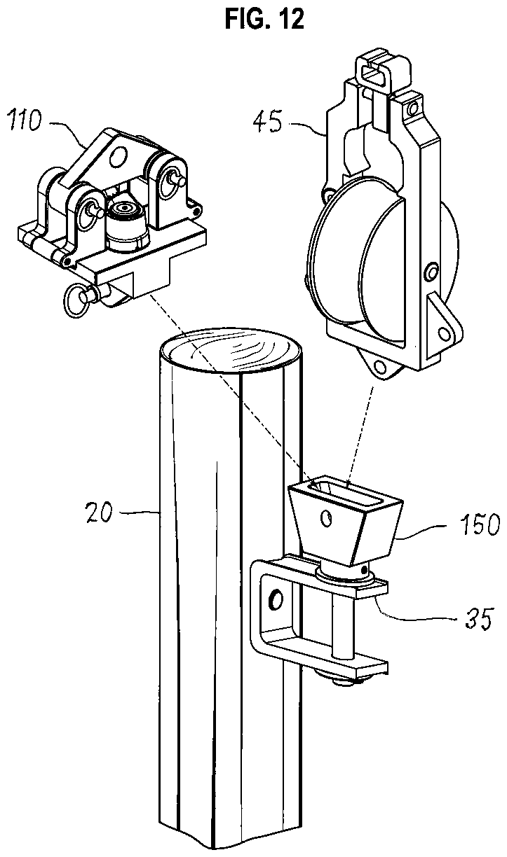

Referring now to FIGS. 8 and 9, the rope brake preferably includes a clevis receiver 150 if it is going to be used with a clevis. The clevis receiver is useful because common methods of temporarily connecting a pulley at or near the clevis are unsatisfactory for temporarily connecting the rope brake. The clevis receiver has a funnel 151 for receiving the downwardly projecting member of the base of the rope brake apparatus. The clevis receiver also has a rod 152 for insertion into the clevis. A pin 153 secures the rope brake to the clevis receiver. The rope brake and the clevis receiver are shown together in FIGS. 10 and 11. FIG. 12 shows that the rope brake fits into a conventional clevis receiver in the same way as a conventional pulley.

2. The Use of The Rope Brake Apparatus

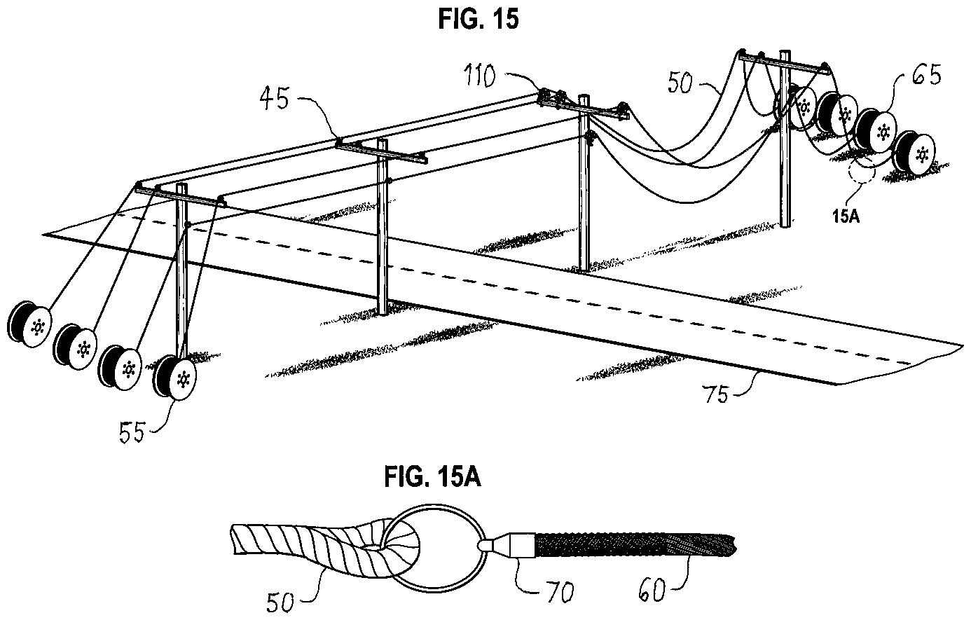

The use of the rope brake apparatus can now be considered. As previously discussed, the method of this invention differs from the conventional method of installing power lines on a span of power poles in one important respect: the rope brake of this invention, instead of a pulley, is placed into a receiver for the initial stringing of the rope. The rope brake is typically used only on poles adjacent a road where a sagging rope would require the road to be closed and/or place a worker at risk. For example, FIG. 15 shows four rope brakes 110 on the pole on the distal (right) side of the road. Conventional pulleys 45 are on the other poles. However, the rope brake can be advantageously used wherever a sagging rope would be a problem.

More particularly, the first step is to mount a conventional crossbar receiver 40 to a crossbar 30 adjacent a conventional insulator 25 on the desired power pole. If a neutral line is being installed, the first step preferably includes connecting a clevis receiver 150 to a clevis 35. The term “power pole” is used herein to refer to any structure to which elevated power lines are attached. The rope brake of this invention is then connected to the crossbar receiver in a similar way to a conventional pulley 45 and then secured with pin 126. For the installation of a neutral line, the rope brake is mounted into the clevis receiver in the clevis. A rope 50 from the proximate end of the span is then passed through the opposed cam cleats and under the retainer. The rope is then pulled through the rope brake. The cam cleats allow movement of the rope in the forward direction, but prevent movement of the rope in the opposite direction. This opposition prevents the rope from sagging down near or onto the ground adjacent the power pole.

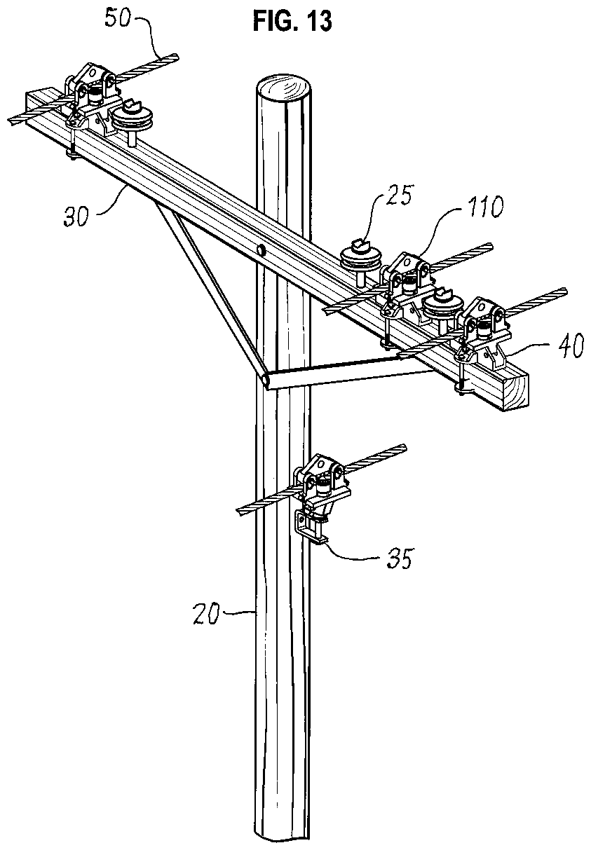

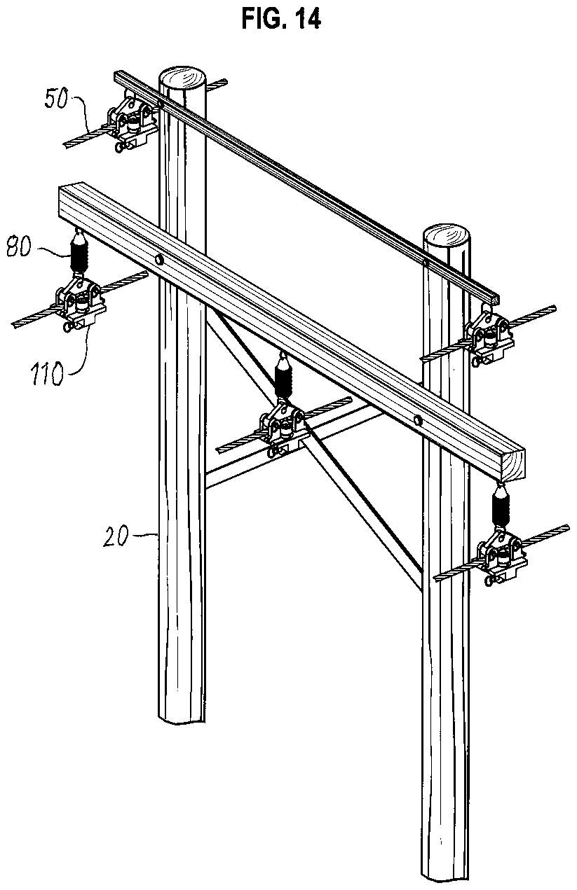

Many installations require the simultaneous installation of three current-carrying lines and one neutral line on multiple power poles. FIG. 13 illustrates a common distribution arrangement with three ropes in place for power lines on a crossbar and one rope in place for a neutral line on a pole-mounted clevis. While most receivers are mounted on the upper surface of crossbars and in a clevis on the side of the pole, some transmission installations have insulators that hang from crossbars. In this situation, the apparatus is connected to the hanging insulator 80 with a fastener that passes through the central hole in the retainer. FIG. 14 illustrates a common transmission arrangement with two ropes for neutral lines in rope brakes hanging from insulators 80 hanging from an upper crossbar above three ropes for power lines hanging from insulators hanging from a lower crossbar.

The leading end of the rope is then connected to the leading end of the power line on a reel at the distal end of the span. As previously discussed, a Kellem grip or the like is commonly used to make the connection as shown in FIG. 15A. The rope is then removed from the rope brake apparatus, the rope brake apparatus is disconnected from the receiver, a conventional pulley is connected to the receiver, and the rope is placed into the pulley.

The rope and the connected power line are then pulled in the opposite direction (from the distal end of the span to the proximate end of the span). Sagging is not a problem during the step because the brake on the power line reel prevents it. When the rope has been pulled completely back to the proximate end of the span and the power line extends across the entire span, the rope is disconnected from the power line. The power line is removed from the pulley and is attached to the adjacent insulator. This procedure is repeated with each power line in the span.

I claim:

1. A rope brake apparatus for controlling the movement of a rope when attached to a receiver, the apparatus comprising:
(a) a base having an upper surface and a lower surface;
(b) a pair of adjacent cam cleats mounted on the upper surface of the base for allowing movement of the rope between them in one direction and for preventing movement of the rope between them in an opposite direction;
(c) two side brackets projecting upwardly from the upper surface of the base for confining the rope;
(d) a retainer removably attached to the side brackets for confining the rope; and
(e) a member projecting downwardly from the lower surface of the base for attachment to the receiver.

2. The rope brake apparatus of claim 1 wherein the cam cleats are mounted in a stationary position on the upper surface of the base.

3. The rope brake apparatus of claim 2 wherein the cleats of the cam cleats have edges that are rounded.

4. The rope brake apparatus of claim 1 additionally comprising a clevis receiver comprising a funnel and a rod.
